(19) United States
(12) Patent Application Publication
(10) Pub. No.: US 2022/0382382 A1
(43) Pub. Date: Dec. 1, 2022

(54) CALLING UP A WAKE-UP FUNCTION AND CONTROLLING A WEARABLE DEVICE USING TAP GESTURES

(71) Applicant: tooz technologies GmbH, Aalen (DE)

(72) Inventor: Kari Kananen, Oulu (FI)

(21) Appl. No.: 17/824,553

(22) Filed: May 25, 2022

(30) Foreign Application Priority Data
Jun. 1, 2021 (DE) 10 2021 205 572.9

(51) Int. Cl. G06F 3/01; G06F 3/0346

(52) U.S. Cl. CPC G06F 3/017; G06F 3/0346

(57) ABSTRACT

The invention relates to a method for controlling a wearable device using tap gestures, in particular at a carrying component of the wearable, wherein measurement data are generated by a sensor and the wearable is controlled when the measurement data are identified as tap gestures at the carrying component.

The invention furthermore relates to a wearable device that can be controlled by tap gestures at the carrying component.

### CROSS REFERENCE TO RELATED APPLICATION

This application claims priority of German patent application no. 10 2021 205 572.9, filed Jun. 1, 2021, the entire content of which is incorporated herein by reference.

### TECHNICAL FIELD

The disclosure relates to a method for controlling a wearable device using tap gestures, in particular at a carrying component of the wearable, wherein measurement data are generated by a sensor and the wearable is controlled when the measurement data are identified as tap gestures at the carrying component.

The disclosure furthermore relates to a wearable device that can be controlled by tap gestures at the carrying component.

### BACKGROUND

Wearable devices, in particular smartglasses, generally use dedicated buttons or a touchpad region for user input. Typical inputs serve to wake up the glasses, that is, to transition them for example from a standby mode to a switched-on mode, to display something on the display or to simply choose between different functionalities. However, separate buttons or touchpad regions require additional hardware and are also difficult to implement in a spectacle frame and not very user-friendly owing to the small size. An additional difficulty consists in that the user wearing the smartglasses cannot see an operating surface located on the smartglasses themselves well, which results in control often being effected “blind”. There is therefore a great need for a simple way of controlling a wearable device, in particular smartglasses, which can be controlled by simple gestures and in which an operating surface is not restricted to a small region the user cannot see. A simultaneous challenge is that smartglasses are frequently worn during a physical activity of the user and gestures and/or other influences acting on the smartglasses that are due to the activity must be reliably differentiated from a control gesture of the user.

### SUMMARY

It is an object of the disclosure to provide a wearable device and a method for operating the wearable device without the disadvantages of the prior art. It is in particular an object of the disclosure to provide a simple and intuitive operating method for a wearable device that is not susceptible to errors and is user friendly while simultaneously being particularly easy and cost-effective to implement. In this respect, it is necessary to reliably differentiate operating gestures from other physical influences acting on the device that typically occur when using the wearable device. Likewise, devices that are switched off or in standby mode should also be able to be operated. It is further an object of the disclosure to provide a particularly user-friendly wearable device that is robust and can be controlled even under difficult conditions and is particularly easy and cheap to produce.

The object can, for example, be achieved via various embodiments of the present disclosure.

In a first aspect, the disclosure relates to a method for controlling a wearable device by recognition of tap gestures of a user at a carrying component, wherein the wearable device comprises the following components: the carrying component configured for an at least temporary fixability of the wearable device to a body of the user, a functional unit that is connected to the carrying component and comprises a visual data output, at least one sensor for measuring interactions caused by tap gestures and at least one integrated circuit. The method includes the steps of generating measurement data by way of the sensor and of controlling the wearable device by way of the integrated circuit by performing a functionality that corresponds to a tap gesture when the measurement data are identified as having arisen due to the tap gesture at the carrying component.

A wearable device is preferably a technical device that is worn on the body and in particular close to and/or on the surface of the skin. It is preferably a technical, in particular an electronic, device having a specific/dedicated functionality especially for the wearer, such as for example outputting and/or gathering and preferably processing data.

A wearable preferably comprises a head-mounted display (HMD), in particular smartglasses, AR glasses, a smartwatch and/or a fitness tracker. A wearable is preferably synonymous with a wearable device.

Tap gestures can be realized preferably by tap movements performed by the hand of the user, in particular by one or more fingers of the user, on the carrying component. Tap gestures comprise in particular a plurality of tap actions, wherein each tap action preferably denotes a single tap. A tap gesture and/or a tap action is in particular a mechanical, intentional action by the user that does not constitute a pure touch and is to be preferably identified as a deliberate gesture.

Rather than fingers, other extremities can also be used for tapping, depending on the practicality, such as parts of the arm, of the shoulder, et cetera. Tapping can preferably also be caused using prosthetics and/or orthotics. A tap action and tapping should here be understood preferably to be synonyms.

The tap gesture preferably comprises all tapping movements and each tap/each tap action performed by the user within a time period, in particular to trigger a control command. A tap gesture can comprise, for example, an individual tap action, effected by the user tapping the wearable once within a time period.

The time period preferably comprises a time duration within which it may reasonably be assumed that a tap gesture is intended to be a contiguous tap gesture to convey a meaningful control command of the user. Such a time period can be ascertained in advance, for example, or by way of trials. For example, such a time period can be 1 second(s), 2 s, 3 s, 4 s, 5 s, 6 s, 7 s, 8 s, 9 s, 10 s, 11 s, 12 s, 13 s, 14 s, 15 s, 16 s, 17 s, 18 s, 19 s, 20 s, . . . 25 s and/or 30 s (that is, preferably a length of 1 s up to 30 s) and/or be selected depending on what tap gesture is expected. Such an expectation can be determined for example on the basis of previous tap actions, which are identified or assumed as part of a tap gesture that is not yet finished or complete.

The time period can preferably be also called tap window in some cases.

For this purpose, it is also possible to preferably use a specific time duration after the last performed tap action. If no further detected tap action falls within such a time duration since the last identified tap action, it is preferably assumed for the purposes of this method that any tap gesture comprising the identified tap actions has concluded. The time duration can preferably have, in terms of time, a length like the time period described above.

A tap gesture preferably assumes a touch of the carrying component effected by the user that is characterized by a relatively short time duration, for example in the sub-second or in the second range. Time scales and/or execution are preferably comparable and/or identical to knocking, for example, knocking on a door. A person skilled in the art knows what is meant by tapping in the field of gesture control.

A functional unit is preferably a unit having functionalities regarding data input, data output and/or data processing. A functional unit can comprise a data interface for data input and/or data output. A functional unit can exhibit functionalities of a smartphone. A functional unit can be, for example a computational unit or a computer. With particular preference, the functional unit includes a visual data output, in particular a visual output unit, for example, a display or a projector. The functional unit can have, in addition to the data output, an interface for communication with an electronic device, for example in order to supplement or expand the electronic device (for example, computer and/or smartphone) in its functionality, in particular in order to allow data input, data output and/or at least partial operation of the electronic device via the functional unit. A functional unit is preferably an electronic, in particular an optoelectronic, functional unit because in particular electrical/electronic and/or optical components are required for the abovementioned functionality of the functional unit.

The visual display unit or visual data output preferably comprises a screen close to the eyes and/or a unit for the visual projection directly onto the retina of a user. The screen close to the eyes is here preferably configured to be transparent, which means in particular that a visual data display and an observation of the region located behind the screen are simultaneously possible. To this end, the data are preferably displayed using suitable means on such a transparent screen, which can have, for example, the dimensions and outer appearance of normal spectacle lenses. The means can comprise a projector whose light rays are projected from the transparent screen to the eyes in an appropriate manner. However, it is also possible for suitable structures to be present in the transparent screen that bring about guidance of light in the transparent screen coming from a suitable light source and/or that brings about corresponding output coupling of the light in the direction of the eye, with the result that an optical display with simultaneous transparency of the screen is made possible for the observer. Such a transparent screen is preferably likewise referred to as a display within this document.

A carrying component of a wearable can preferably comprise a carrying frame (in the case of a HMD for example a spectacle frame), a carry strap such as for the head (HMD) and/or a wrist strap (for example, for smartwatch, fitness tracker). A HMD is preferably a visual output device that is to be worn on the head. A HMD is in particular selected from the group comprising data glasses, helmet-mounted display, video glasses, first person view glasses (FPV glasses), virtual reality headset (VR headset), augmented reality glasses (AR glasses), smartglasses, spectacles comprising at least one visual display unit (display).

A fixability of the wearable device to a body of a user which is at least temporary should preferably be understood in this context. For example, smartglasses are put on by a user for wearing them and removed again as required. In this case, the earpieces of the spectacle frame are typically placed behind the ears for wearing the glasses. This preferably corresponds to an example of temporarily fixing the wearable device to a body. Another example would be putting on a wrist strap for wearing a smartwatch.

The body of the user here preferably denotes the body of the wearer of the wearable. In particular, the body comprises one or more body parts, such as the head, the hand and/or the arm, and/or parts of body parts, such as the eye area, the forehead, the ears, the circumference of the head, the wrist, the upper arm, et cetera.

A carrying component is in this case configured in particular for at least temporarily wearing the wearable device on a body (part) of a user in a force-fitting and/or form-fitting manner.

The at least one sensor for measuring interactions caused by tap gestures is preferably set up for measuring interactions caused by tap gestures. This means in particular that it must be suitable for measuring interactions caused by tap gestures.

Interactions caused by tap gestures are preferably measurable interactions or mechanical influences of a person with that of the carrying component, in particular of the wearer wearing the carrying component, that are due to tap gestures. Interactions caused by tap gestures can comprise specific characteristics, for example producing specific accelerations or having specific touch durations on the basis of which a tap gesture can be differentiated from other effects. The sensor for measuring interactions caused by tap gestures is preferably capable in principle of measuring the corresponding physical variables, comprise the characteristics or from which the characteristics can be extracted using a suitable algorithm.

The at least one sensor can comprise for example an acceleration sensor and/or a touch-sensitive sensor. Preferably, a plurality of sensors, for example, 2, 3, 4, 5, 6, 7, 8, 9, 10, . . . 12, . . . 15, . . . , 20, 30, 40, 50 or 100 sensors may be comprised, depending on how many sensors are required or most appropriate for performing the method. Additionally, combinations of at least one acceleration sensor and at least one touch-sensitive sensor can preferably be used.

A touch-sensitive sensor can preferably comprise an optical, capacitive, resistive and/or inductive sensor. A selection from this group can be made for example in consideration of whether a tap gesture is to be made only by direct contact of the skin (or of an electrically conductive object) of the operator with the carrying component or whether textiles (for example, gloves) or objects (prosthetics, et cetera), which are in particular electrically non-conductive, can be used for a tap gesture as well.

The words wearer, user and/or operator used in this document are preferably to be understood to be synonymous.

An acceleration sensor preferably measures the acceleration it experiences. An acceleration can preferably comprise linear acceleration and/or rotational acceleration. An acceleration sensor can preferably comprise a piezoelectric sensor, a microsystem, a strain gauge and/or a sensor for measuring acceleration based on magnetic induction. In particular, the acceleration sensor can comprise a microelectromechanical system (MEMS). The acceleration sensor can preferably also be called accelerometer within this document.

The at least one sensor preferably produces measurement data. The measurement data can comprise a continuous electrical signal that produces for example measurement information which is coded in the electrical current intensity and/or the level of the electrical voltage. The measurement data can likewise comprise a time series of measurement signals, wherein each measurement signal can comprise for example an electrical signal of finite length, wherein the measurement information can preferably be coded in the electrical current intensity and/or the level of the electrical voltage. A time series of measurement signals preferably comprises a plurality of such measurement signals that have a temporal distance from one another. Preferably no measurable electrical signals and/or substantially constant electrical signals are present between the measurement signals. The measurement signals of the time series are preferably spaced apart from one another by a substantially constant temporal distance. The measurement data can be present in analogue form or in digital form. In the case of the digital form, the measurement information is preferably present in discretized form.

If at least one acceleration sensor is employed, the measurement data comprise for example the acceleration (transversal and/or rotational) experienced by the carrying component within an inertial system or a system that can be considered at least approximately as an inertial system (for example, a reference system linked to the Earth's surface).

The measurement data can likewise comprise data of a touch-sensitive sensor that comprise information relating to touches of the carrying component by the wearer, for example, the size and/or a change in the size of a touch surface, the duration of a touch, et cetera.

The measurement data can likewise comprise combinations of measurement data of at least one acceleration sensor and in the measurement data of at least one touch-sensitive sensor.

The method comprises generating measurement data by way of the sensor and controlling the wearable by performing a functionality that corresponds to a tap gesture when the measurement data are identified as having arisen due to tap gestures (or at least a tap gesture) at the carrying component. For example, measurement data can be compared to stored data that comprise reference data for tap gestures, in particular specified or known tap gestures at the carrying component. If the measurement data or part of the measurement data correspond to the reference data or if the measurement data are sufficiently similar thereto, the corresponding part of the measurement data is considered, identified or interpreted as a tap gesture.

In this case, the measurement data are preferably examined as to whether they could have arisen due to a tap gesture. A specific time duration is preferably considered here.

For this purpose, for example an integrated circuit can be comprised by the wearable device, for example, in the carrying component. An integrated circuit is preferably an electronic circuit having a fixed and/or (partially) programmable functionality, such as for example reading measurement data and/or evaluating measurement as data as described herein, in particular in order to identify measurement data as having arisen due to a tap gesture at the carrying component. The integrated circuit preferably then performs a functionality corresponding to the tap gesture after the identification. For this purpose, for example depending on the tap gesture that is identified, it is possible to output a control command that then takes care of performing a corresponding functionality. A control command here comprises for example a control command issued to the functional unit. An integrated circuit can comprise, for example, a (micro-) processor.

A tap gesture can preferably be assigned to a control command by the device or to a functionality and is thus “known” to the device. Such an assignment or knowledge relating to a tap gesture may have been specified ex works during the production of the wearable or be “taught” by the user, who performs, by way of suitable inputs, his own assignment of a tap gesture to a functionality, which is then preferably stored, for example, in a memory of an integrated circuit.

Tap gestures can preferably have different characteristics, as will be explained in more detail below. A tap gesture preferably comprises at least one tap action. Such a tap action preferably brings about a specific signature of the measurement data of the sensor that can preferably be identified, for example using the above-described methods.

Consequently, the following method is preferably also possible for differentiating tap gestures: First, an individual tap action or an individual tap is preferably identified from the measurement data. In relation to this tap action, characteristics of the tap action can then be stored, for example a tap time point and/or a number/chronological numbering of the tap actions within a time period. The determination as to whether this is a (known) tap gesture is here preferably made on the basis of the at least one characteristic. If the tap gesture comprises for example a single tap action, the numbering/number can be the decisive criterion for the assignment to a known tap gesture, for example, a tap gesture with a single tap. With this method, there is no need to compare complex data consisting of relatively long time series but merely characteristics of individual tap actions that are abstractly relatively easy to store, as soon as these have been identified as such by the control unit.

If the tap gesture is identified, a functionality corresponding to the tap gesture is performed or “ordered” by the regulating unit. The functionality can here be performed by other components of the wearable device, for example, comprising the functional unit. For this purpose, preferably a corresponding signal is generated, for example, by an integrated circuit.

The intention is to identify tap gestures at the carrying component. Tap gestures taking place only at the carrying component rather than at the functional unit or elsewhere are preferably intended to be identified.

The carrying component can comprise for example a spectacle frame of smartglasses. To the spectacle frame preferably comprises two temples, one for each side of the head, which are preferably used to fix the spectacle frame to the head of the user.

It can also be preferred that tap gestures at the carrying component and in regions of the wearable that adjoin the carrying component (for example, regions of the functional unit) are identified as tap gestures at the carrying component.

It may furthermore be preferred for tap gestures taking place at the entire wearable to be identified, which in particular comprises the carrying component.

In particular it is preferred for tap gestures taking place at least at the carrying component to be identified, wherein the identification of tap gestures outside the carrying component is not excluded, but wherein the method is configured, in particular, to identify tap gestures at the carrying component. It may be advantageous here to adapt a number and/or spatial arrangement of the sensors and/or the sensor type used, such that identification of any tap gesture taking place at the entire carrying component can be reliably made possible.

Identification of tap gestures in a region of the wearable device (at least or only the carrying component), as described above, can be ensured for example by a computer-assisted development and/or detailed test series in a development phase of the wearable device and/or of the control method.

In order to identify tap gestures, as described above, at the carrying component or in a region that comprises at least the carrying component, preferably at least one suitable sensor is used. Sensors (at least one) are positioned in a number adapted to the requirements and circumstances and/or at least at one suitable location, for example inside or on the carrying component. It is possible here for there to be minimum and maximum requirements relating to the sensor and to the number and attachment location that are preferably taken into account to make an effective and efficient method possible. For example, acceleration sensors with a low sensitivity, for example a sensitivity of greater than 10 nanog (wherein g preferably corresponds to the average acceleration due to gravity), with greater preference greater than 100 ng (nanog), with even greater preference 1 mg (millig) or above, can be advantageously used because no higher sensitivity is required. For example, a basic MEMS accelerometer could be used, which has a sensitivity of around 1 mg/digit. So, advantageously, particularly robust and cost-effective sensors can therefore be used. One example of such a sensor would be the STM LIS2DW12.

It can be preferred that a detection threshold is set in order to avoid false detections. This detection threshold is preferably higher than the above mentioned sensitivities.

Preferably, the sensor comprises configurable measurement characteristics, such as threshold, sensitivity levels, tap windows et cetera.

It is preferred that the at least one accelerometer is located in the at least one temple of the spectacle frame. The front frame, which preferably comprises the glasses and or the visual data output typically has very limited space for components.

It is preferred that the sensor is located in the carrying component, preferably on the same side of the carrying component where the tapping gesture is supposed to occur, for example. The temple that is tapped, for example by a finger.

It can be possible that tapping on the opposite side of the carrying component where the sensor is located, for example, the opposite temple, would not be recognized reliably due to a preferred construction of the spectacle frame, i. e. flexible hinges and the temples being in contact with the head of the user most like suppress the acceleration. It is thus preferred that there is more than one sensor comprised, one in each region where a tapping gesture is supposed to occur, in order to have a reliable recognition of taps and at the same time flexibility on where to apply the tapping gesture. If the carrying component comprises a spectacle frame with temples, it is, for example, preferred to have one sensor on each temple to allow reliable recognition of taps. When using a plurality of sensors, it may be preferred in particular when using acceleration sensors to implement a location determination of the origin of a measured signal by comparing signals of the individual detectors. This can be accomplished, for example, by triangulation. For example, it may thus be established whether an acceleration signal has its origin inside the carrying component, as would be the case for a tap gesture at the carrying component, or not. In this way, the operating reliability can be increased.

A particularly user-friendly control that is especially protected against incorrect operations by the user can be implemented with the method. This is advantageously realized by the use of tap gestures for the operation. Tap gestures can be performed particularly easily and intuitively and do not require any particular fine-motor coordination. In addition, this is achieved by the tap gestures being able to be performed at any point inside/on the carrying component. In a wearable according to the disclosure, the carrying component typically has a size and/or is configured for an arrangement on the body (for example, on the head or the wrist) that is particularly suitable for easy and intuitive operation. For example, it is very easy even under adverse circumstances to touch a spectacle frame by tapping gestures. In a typical example, a user wears the wearable in the form of AR glasses while cycling. The cyclist requires concentration for the task of cycling and is moreover exposed to possible shocks and/or vibrations due to the underlying ground travelled on. Owing to the method according to the disclosure, the user will nevertheless be able to operate the AR glasses by way of tap gestures at the spectacle frame because this advantageously requires little additional concentration and fine-motor coordination.

In an embodiment of the disclosure, identifying measurement data that arose due to a tap gesture at the carrying component additionally comprises differentiating between measurement data that arose due to movements and/or touches of the carrying component that are not caused by tap gestures at the carrying component and measurement data that arose due to movements and/or touches of the carrying component that are caused by tap gestures at the carrying component. In this case, the at least one sensor is preferably a touch-sensitive sensor and/or an acceleration sensor. In continuation of the previously mentioned example of the AR glasses worn while cycling, a distinction will have to be drawn for example between accelerations caused by tap gestures at the carrying component and accelerations caused by the cycling activity per se and any shocks.

It is therefore preferably possible to allow identification of an acceleration due to a tap gesture in the measurement data of at least one acceleration sensor. It is necessary here to distinguish (for example by way of the integrated circuit) whether a measured acceleration is due to, for example, a movement of the user or to a tap gesture. Typically, these two “types of acceleration” may superpose, wherein the acceleration due to the tap gesture must be identified from the superposed types of acceleration comprised in the measurement data.

It is likewise possible to allow for example identification of a touch due to a tap gesture in the measurement data of at least one touch-sensitive sensor. It is necessary here to differentiate (in particular by way of the integrated circuit) whether a measured touch is caused by a long-term touch caused by wearing the wearable or by a tap gesture. Typically, these two “types of touch” superpose, wherein the touch due to the tap gesture must be identified from the superposed types of touch comprised in the measurement data. A long-term touch caused by wearing is caused in particular by contact of the region for example with parts of the body of the wearer/user. For example, the spectacle frame, for example the ear pieces, permanently touches parts of the body (for example the ears) of the wearer while being worn.

This can be accomplished for example with suitable circuits and/or algorithms that have been correspondingly adapted for example based on computer-assisted development and/or a sufficient quantity of “training data”, for example with the aid of artificial intelligence (AI). This preferred variant offers operation that is particularly insusceptible to errors.

In an embodiment of the disclosure, the integrated circuit comprises a control unit or is comprised in a control unit.

The control unit is preferably configured for controlling the wearable device.

A control unit is preferably an electrical or electronic computation unit. A control unit can comprise at least one data input, a data output and/or a data memory. A control unit is in particular an integrated circuit (for example within the meaning of the description above) that performs data processing of available data (for example, at the data input), for example storage and/or logic operations. Output of data depending on the available data can take place (for example, at the data output). A control unit can be implemented for example by a (micro-) processor, in particular by an ASIC or a programmable processor (for example, FPGA, CLP).

A control unit is preferably a local component, that is, a component comprised in the wearable device, which requires no further external components (components not comprised in the wearable device).

A control unit should in particular be understood in the functional sense as a unit that is separate from the sensor, wherein the sensor produces measurement data (for example, relating to the acceleration) and the control unit preferably reads and/or processes the data. However, it may be preferred that the at least one sensor and the control unit form a unit in the structural sense and are present for example in an integrated form and/or are housed in a common housing. In the functional sense, the control unit can also be understood in so far as the control unit that fulfills the functionality with respect to the disclosure or an embodiment is implemented in an actual device by way of a plurality of separate and preferably electrically interconnected integrated circuits.

It is preferred that the control unit controls the standard operation of the wearable device. In particular, a control unit is connected to the energy supply of the wearable device and is in a common operating state therewith, for example switched on, switched off and/or on standby.

It may likewise be preferred that the control unit monitors and/or regulates proper operation of the sensor.

The sensor preferably produces electrical signals that can be read and/or processed by the control unit. The signals can be in particular at least in part digitized signals.

It may be preferred that a step is comprised in which, after the measurement data have been produced, the measurement data are transferred to the control unit.

The control unit is preferably configured for controlling the wearable device. This means in particular that performing a functionality corresponding to a tap gesture, when the measurement data are identified as having arisen due to the tap gesture at the carrying component, can be effected by the control unit. This preferably means both the identification process and the performance of the functionality. For the identification process, the measurement data are preferably transferred from the at least one sensor to the control unit and/or read thereby. The identification process is then preferably implemented by a corresponding circuit comprised by the control unit and/or by an algorithm that is able to be performed or is performed on the control unit. Methods described above can be used herein.

The control unit being configured for controlling the wearable device moreover preferably means that the controlling of the method does not need to be performed by the control unit but rather can also be performed by another unit comprised in the device. Which unit performs the controlling can depend on circumstances. At any rate, the control unit is in principle set up for such control.

The statements made with respect to the control unit here can preferably also, mutatis mutandis, be applied to the regulating unit described in this document.

The measurement data are preferably read at least at one data input of the control unit. Reading in particular comprises capturing the measurement signal. The measurement signal is here preferably read continuously or in discrete, preferably regular time distances, in particular at a specific sampling rate that is suitable for the method. A person skilled in the art knows how to determine a suitable sampling rate for the method depending on the boundary conditions. A sampling rate can be for example of the order of magnitude of 100 hertz (Hz), 1 kilohertz (kHz), 10 kHz, 100 kHz, 1 megahertz (MHz), 10 MHz, 100 MHz or 1 gigahertz (GHz).

The reading is preferably followed by identifying whether the measurement data arose due to a tap gesture at the carrying component. In this case, the read signal is preferably examined by the control unit as to whether the measurement data could have arisen within a specific time period by a tap gesture.

Identifying or examining the measurement signal comprises for example a computation operation, in particular an algorithm, which is applied to the measurement data. A simple algorithm can comprise a comparison of the measurement data to previously stored values, in particular threshold values, wherein it is preferably assumed, that if a threshold value is exceeded, the available measurement signal was caused by a tap gesture. It is likewise possible using the control unit to compare a time series of measurement signals to stored time series of measurement signals. If the comparison yields a substantial match or a sufficient similarity of the signals compared, it is preferably possible to identify by way of the control unit, that the compared signal was caused by a known tap gesture.

If the known tap gesture is identified, a functionality corresponding to the known tap gesture is performed or “ordered” by the control unit. In particular, the performance is instructed by the control unit, but the actual performance can be undertaken by other components of the wearable, for example the functional unit. For this purpose, at least one corresponding construction signal is produced preferably at least at one data output of the control unit.

Such control of the wearable is particularly reliable. It is thus possible to implement improved identification of tap gestures.

In a further preferred embodiment of the disclosure, the controlling by way of the control unit comprises the following steps:
a. establishing a similarity of the measurement data with stored data patterns of tap gestures
b. assigning the measurement data to the most similar tap gesture when a sufficient similarity is established.

The data patterns can be available for example stored ex works or they can have been learned, for example by a learning mode by virtue of a user being requested to perform a tap gesture a number of times according to instructions.

A similarity with data patterns can be established in particular with the aid of statistical evaluation, the user “practising” a gesture at the device and/or by artificial intelligence.

“Practising” a user gesture at the device preferably comprises the following steps:
specifying a tap gesture
the user performing (preferably multiple times) the specified tap gesture
storing at least one data pattern of the tap gesture performed, preferably comprising a statistic in this respect (which may be characteristic and/or be used to measure similarity).

A similarity between measurement data and data patterns can preferably be measured by the control unit using a corresponding algorithm online (preferably substantially at the same time as the reading of the measurement data) and/or offline (preferably after storing at least a portion of the measurement data but in particular without a time lag that is noticeable to the user). It is possible here to use methods of statistical similarity analysis known to a person skilled in the art, such as using the similarity measures according to Braun, Dice, Hamann, Jaccard (S-coefficient), Kappa, Kulczynski, Ochiai, Phi, Russell Rao, simple matching (K-coefficient), Simpson, Sneath, Tanimoto (Rogers) and/or Yule. It is likewise possible to use distance measures known to a person skilled in the art, for example generally Lᵣ, Euclidean (L₂), according to Pearson, City Block Manhattan (L₁), Gower and/or Mahalanobis, to measure the similarity.

In this case, measurement data and data patterns is preferably shifted with respect to one another to establish the similarity at different time points.

A sufficient similarity can be present for example when a threshold value of a measure representing the similarity is reached or exceeded. The measure can preferably be referred to as similarity, and a similarity greater than, or greater than or equal to, the threshold value can be referred to as sufficient similarity.

If there are sufficient similarities with respect to different data patterns, preferably the data pattern or the tap gesture associated with the data pattern that has the greatest similarity is assigned.

In this way it is possible for tap gestures to be identified particularly reliably and flexibly. Even if the deviation of a tap gesture that has actually been performed from a “perfect” tap gesture that corresponds exactly to the stored data pattern can for individual reasons be significant, the tap gesture can in this way advantageously still be identified despite the deviation. The user-friendliness can be increased and the operability in situations that require great concentration from the user on another matter can be ensured.

In a further preferred embodiment of the disclosure, the sensor comprises an integrated circuit in the form of an internal regulating unit. Preferably, this unit is a further integrated circuit in addition to the control unit. In this context, the document preferably refers to a second integrated circuit.

In an embodiment, the internal regulating unit is preferably configured for controlling the wearable device.

In an embodiment, controlling the wearable device is preferably effected in dependence on the functionality, the tap gesture and/or an operating state of the wearable device either by the internal regulating unit or by the control unit.

However, it may also be preferred that the internal regulating unit is the only integrated circuit of the wearable device.

The internal regulating unit (of the sensor) is preferably an integrated circuit, preferably a (micro-) processor used to regulate the sensor. The primary tasks of the regulating unit can comprise for example: monitoring the power supply of the sensor, monitoring further operating parameters of the sensor, implementing a first evaluation of the measurement data and/or digitizing analogue measurement data (D/A converter). Moreover, in some embodiments, the regulating unit can preferably allow identification of whether the measurement data have arisen due to the tap gesture at the carrying component. In this document, reference is sometimes made to the regulating unit when the internal regulating unit is meant.

The aforementioned properties and definitions with respect to a control unit can likewise apply, mutatis mutandis, to the regulating unit. A regulating unit can comprise for example a trimmed-down control unit that has less computational capacity and/or storage compared to the control unit.

However, it can also be preferred that the regulating unit comprises a very simple electronic component, which is merely capable to differentiate measurement data of the sensor above or below a specific threshold value. Then, a threshold being exceeded can, for example, indicate that a tap action has taken place. Such a regulating unit can additionally comprise a counter for counting previously established tap actions, which is reset to zero preferably at the moment a specific time duration has passed.

The regulating unit is preferably comprised by the sensor. This means in particular that both are present in a common, preferably compact housing that comprises preferably at least one data output, preferably a data input and preferably a connection for supply with electrical energy. However, it can also be preferred that the sensor has its own electrical energy supply, for example, a battery. The latter can be in particular independent of the energy supply of the rest of the wearable device.

The sensor comprising the regulating unit is preferably connected to its own electrical energy supply (or comprises such an energy supply) and/or functions independently of the operating states of the wearable device (on, off and/or standby). The sensor preferably is permanently supplied with electrical energy and/or the operating state of the sensor is controllable via its own switch.

The regulating unit is preferably configured for controlling the wearable device. This means in particular that performing a functionality corresponding to a tap gesture, when the measurement data is identified as having arisen due to the tap gesture at the carrying component, can be effected by the regulating unit. This preferably means that both the identification process and the execution of the functionality can be performed by the regulating unit. For the identification process, the measurement data is preferably transferred from the at least one sensor (preferably the measurement unit of the sensor) to the internal regulating unit and/or read out thereby. The identification process is then preferably implemented by a corresponding circuit comprised by the internal regulating unit and/or by an algorithm that can be performed or is performed on the regulating unit. Methods described above can be used herein.

The regulating unit being configured for controlling the wearable device preferably means that the method of controlling can be performed by the regulating unit, but does not need to be performed by the regulating unit. It can also be performed by another unit (for example, the control unit) comprised in the device. Which unit performs the controlling can depend on circumstances. At any rate, the regulating unit is in principle set up for such control.

Whether the controlling of the wearable device is effected by either the regulating unit or the control unit preferably depends on the functionality, the tap gesture and/or an operating state of the wearable device.

For example, the sensor is suitable to independently identify simple tap gestures via the regulating unit. The regulating unit is here preferably limited to identifying simple tap gestures or characteristics of tap actions which are easy to measure.

It may be preferred to use the regulating unit for identifying tap gestures only in specific operating states of the wearable device, for example when the device and/or the control unit is switched off or in standby mode and therefore the control unit is switched off as well and cannot be used for identifying tap gestures. It may be preferred that the regulating unit has less computational power and/or storage space than the control unit and therefore more complex algorithms for identifying tap gestures can be performed only by the control unit and not by the regulating unit of the sensor.

Controlling can also preferably be effected by the sensor itself in the case of specific functionalities, in particular simple functionalities.

A “decision” as to whether the controlling based on the stated criteria is effected by the regulating unit or the control unit can be based for example on the operating state or the tap gesture. For example, it may be that the regulating unit is technically or by configuration only capable of identifying simple tap gestures. If such tap gestures are identified, control is effected by the regulating unit. In other cases, the measurement data are passed on to the control unit, which is typically arranged downstream (regarding the measurement data flow) of the regulating unit of the sensor, wherein the control unit then undertakes the control depending on the tap gesture that has been identified. A decision according to the functionality is preferably based on the tap gesture, wherein each tap gesture is associated with a functionality. The functionality can likewise be based on the current operating state. For example only limited functionalities are available in specific operating states, for example, the functionality of switching on when the device is in a switched-off mode or the functionality of the wake-up function when the device is in standby mode. It may furthermore be that a control unit is simply not available, because it has been switched off or is in standby mode.

Identification of the tap gesture and according performance of the control method by the regulating unit of the sensor can represent a particularly fast and simple implementation of the operating method in which no data need to be additionally transferred to the control unit. This may be particularly practical for example if the sensor is supplied by its own electrical energy supply and/or a primary power supply, even when other parts of the device are in standby mode or in a switched-off mode and receive no power. In that case, identification and performance can nevertheless be ensured by the sensor or its regulating unit.

In a further preferred embodiment of the disclosure, the controlling is performed by way of the internal regulating unit
i. when the wearable device is switched off or in standby mode
and/or
ii. when a functionality comprises a wake-up function, switching the wearable device on and/or off
and/or
iii. when the tap gesture is a simple tap gesture that is defined by a number of tap actions, which preferably lies under a maximum number.

Preferably, only the sensor and thus the internal regulating unit are supplied with power when the wearable device is switched off and/or in standby mode. It is thus possible in these operating states that only the regulating unit performs the control. Control can here be effected in particular by performing a wake-up function or switching the device on when corresponding tap gestures are put in and identified.

A wake-up function can be used to switch from standby mode or standby operation (preferably also referred to by the skilled person as sleep mode) into an (active) operating mode.

A simple tap gesture is primarily (only) dependent on the number of the tap actions. It preferably has a maximum number of tap actions. This maximum number can be 3, 4, 5 or 6, for example. These simple tap gestures can be identified particularly well by the regulating unit even if the latter has a simple electronic setup, in particular compared to the control unit.

It is particularly preferred and practical to enable a wake-up function, a switching on and/or switching off by simple tap gestures. It is in particular practical if the simple tap gesture is identified by the regulating unit of the sensor. It is thus possible, especially for controlling a wake-up function from a standby mode or for switching-on, to still ensure control of the rudimentary functions by simple tap gestures even if the control unit is switched off.

In a further preferred embodiment of the disclosure, the tap gesture is a simple tap gesture, wherein the controlling by way of the internal regulating unit comprises the following steps:
a. counting the number of tap actions
b. assigning the tap actions to the simple tap gesture according to the number of tap actions.

The counting of the number of tap actions preferably comprises as a first step identifying tap actions.

The tap actions are preferably counted per unit time. The latter can have a length that is reasonable in view of the method and in particular in view of the task of identifying tap gestures. The time unit can be identical for example to the time period defined above.

Identification of a simple tap gesture can be realized here in a particularly resource-saving fashion. This means in particular that a very easy and consequently advantageously fast and/or energy-saving algorithm that is insusceptible to error can be used.

The use of a simple tap gesture for the implementation is particularly intuitive in particular for performing the aforementioned base functionalities (preferably wake-up, on/off) because such gestures are particularly easy and quick to learn for the user and the stated base functionalities must be used particularly frequently.

In a further preferred embodiment of the disclosure, a simple tap gesture comprises at least one tap action and at most four tap actions, in particular one tap action, two tap actions and/or three tap actions.

In particular, a simple tap gesture comprises at least one tap action and at most four tap actions per unit time, in particular one tap action, two tap actions and/or three tap actions per unit time.

Such tap gestures are particularly intuitive and easy to remember.

In a further preferred embodiment of the disclosure, the controlling is effected by way of the control unit
i. when the wearable device is switched on and/or
ii. when the tap gesture is a complex tap gesture.

A switched-on wearable device here comprises in particular a switched-on control unit. As soon as the control unit is switched on, it preferably assumes control. This makes sense in particular because the control unit preferably has a higher computational and/or storage capacitance than the regulating unit and is provided primarily for the task of controlling the device, in particular when basic functionalities are not involved.

It may likewise be preferred that a control unit is also responsible for controlling basic functionalities and/or identification and performance according to simple tap gestures as soon as the device and in particular the control unit are switched on because it can identify tap gestures in a particularly reliable manner.

A complex tap gesture is here in particular a tap gesture that is not a simple tap gesture. Complex tap gestures can be identified particularly well by the control unit because it preferably has a higher computational and/or storage capacitance than the internal regulating unit. Complex tap gestures are preferably likewise linked to more complex functionalities than simple tap gestures. In this case, the control unit is preferably likewise better suited to performing them for the aforementioned reasons. It may be preferred that a complex tap gesture cannot be identified by the sensor or its regulating unit but only by the control unit.

By performing control by way of the control unit in particular in the stated cases, improved control can be implemented.

In a further embodiment of the disclosure, a complex tap gesture comprises a plurality of tap actions, wherein the complex tap gesture is defined by a tap duration of the tap actions, a tap intensity of the tap actions, a tap period of the tap actions, a tap rhythm of the tap actions and/or a number of tap actions of greater than four.

In a further embodiment of the disclosure, a complex tap gesture comprises a plurality of tap actions per unit time, wherein the complex tap gesture is defined by a tap duration, a tap intensity, a tap period and/or a tap rhythm of the tap actions per unit time.

Complex tap gestures can be characterized, for example, by a plurality of tap actions performed in respectively different rhythms and/or intensities. A tap frequency can be preferably calculated from the tap period.

To identify such a complex tap gesture, it is thus also possible to use the method that has already been introduced above, in that first an individual tap action or an individual tap is preferably identified from the measurement data and at least one characteristic of the tap action is stored in relation to the tap action, wherein the characteristic is selected for example from the group comprising tap duration, tap intensity, tap period and/or tap rhythm. The at least one characteristic is compared preferably to at least one stored known characteristic of a known complex tap gesture and identified in the case of a match or sufficient similarity (for example, with a method as described above).

Such complex tap gestures can be learned and/or remembered particularly easily by a user. Individualization is also particularly easily possible by a learning mode in which the user can program individual tap gestures for controlling purposes using complex tap gestures that are thus defined.

In a further embodiment of the disclosure, the sensor comprises an acceleration sensor, wherein the measurement data comprise acceleration data of the carrying component.

An acceleration sensor is particularly well suited for producing suitable measurement data for identifying tap gestures. Tap gestures preferably have a particular acceleration profile that can be measured by the sensor and subsequently be identified based on the measurement data.

An acceleration sensor is particularly compact, cost-effective and reliable. Standard components can be used particularly well.

In a further aspect, the invention relates to a wearable device, preferably for performing the method as described above. The wearable device comprises a carrying component configured for at least temporarily fixing the wearable device to a body of a user, a functional unit that is connected to the carrying component and comprises a visual data output, at least one sensor for measuring interactions caused by tap gestures and at least one integrated circuit. The sensor and integrated circuit are configured for controlling the wearable device by way of a tap gesture at the carrying component, wherein measurement data of the sensor serve as the basis.

The wearable device being configured for controlling the wearable device by way of a tap gesture at the carrying component, wherein measurement data of the sensor serve as the basis, means in particular that the wearable device is set up to perform a method described in this document.

A person skilled in the art can see that advantages, definitions, and embodiments of the method according to the disclosure likewise apply to the claimed device according to the disclosure.

In an embodiment of the disclosure, the sensor and integrated circuit are configured for performing a functionality that corresponds to the tap gesture when measurement data of the sensor are identified as having arisen due to the tap gesture at the carrying component.

The sensor and integrated circuit being configured for performing a functionality that corresponds to the tap gesture when measurement data of the sensor are identified as having arisen due to the tap gesture at the carrying component in this case means in particular that the sensor and integrated circuit are set up to perform a method described in this document.

In a further embodiment of the disclosure, the integrated circuit comprises a control unit, and the sensor and control unit are configured for performing a functionality that corresponds to the tap gesture when measurement data of the sensor are identified as having arisen due to the tap gesture at the carrying component.

The sensor and control unit being configured for performing a functionality that corresponds to the tap gesture when measurement data of the sensor are identified as having arisen due to the tap gesture at the carrying component in this case means in particular that the sensor and control unit are set up to perform a method described in this document.

It preferably means that the sensor and control unit are connected to one another at their respective data inputs or data outputs by data transfer paths (wireless or cable-bound). It additionally preferably means that the control unit is connected to the remaining device, in particular the functional unit, in the same way via signal lines or signal paths and can thus instruct and/or control the performance of functionalities. It likewise preferably means that the sensor is suitable for producing corresponding data and the control unit is suitable for reading and/or processing the data, for example by way of a suitable electronic circuit and/or using corresponding algorithms that can be performed by the control unit.

In a further embodiment of the disclosure, the sensor comprises an integrated circuit in the form of an internal regulating unit, wherein the sensor and internal regulating unit are configured for performing a functionality that corresponds to the tap gesture when measurement data of the sensor are identified as having arisen due to the tap gesture at the carrying component.

The internal regulating unit is preferably a second integrated circuit. In this case, the internal regulating unit and control unit are set up for controlling the wearable device by way of the internal regulating unit or by way of the control unit depending on the functionality, the tap gesture and/or an operating state of the wearable device.

However, it may also be preferred that the internal regulating unit is the only integrated circuit of the wearable device.

The statements above relating to the control unit preferably apply, mutatis mutandis, to the internal regulating unit.

The internal regulating unit and the control unit being set up for controlling the wearable device by way of the internal regulating unit or by way of the control unit depending on the functionality, the tap gesture and/or an operating state of the wearable device preferably means that they are configured for the method described above, in which control is effected by one or the other unit depending on the functionality, tap gesture and/or operating state.

In a further embodiment of the disclosure, the sensor comprises an acceleration sensor, and the measurement data comprise acceleration data of the carrying component.

In a further embodiment of the disclosure, the wearable device includes a head-mounted display. In this way, a particularly user-friendly head-mounted display can be provided.

### BRIEF DESCRIPTION OF THE DRAWING

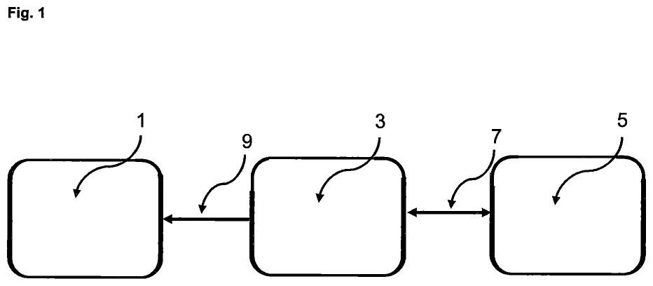

The invention will now be described with reference to the single FIGURE of the drawing (FIG. 1) which shows a schematic method sequence for controlling a wearable device by tap gestures.

### DESCRIPTION OF THE PREFERRED EMBODIMENTS

FIG. 1 schematically shows the method sequence for controlling a wearable device by tap gestures. In this case, in particular the functional unit comprising a visual data output 1 is intended to be controlled. Initially, a sensor 5, for example an acceleration sensor, generates measurement data (for example acceleration data), especially with respect to the carrying component of the wearable device. The measurement data in this simple embodiment are transferred 7 to the control unit 3, wherein the control unit 3 can monitor appropriate operation of the sensor 5. The control unit 3 controls the wearable device 9 if the measurement data of the sensor 5 are identified as having arisen due to tap gestures at the carrying component. For this purpose, the measurement data are preferably read by the control unit 3 and, for example using a corresponding algorithm and/or by comparing it to stored data, it is hereby identified whether the measurement data correspond to a tap gesture in the region of the carrying component. Controlling the device 9 by way of the control unit 3 can be effected by performing a functionality corresponding to the tap gesture when the tap gesture is identified. Rather than the control unit 3, it is also possible for an internal regulating unit of the sensor 5 to act. In that case, the shown division with separate units should be understood to be merely functional because the internal regulating unit is preferably physically comprised by the sensor 5.

The sensor 5 and/or the control unit 3 are advantageously configured for identifying a tap gesture at the carrying component.

It is understood that the foregoing description is that of the preferred embodiments of the invention and that various changes and modifications may be made thereto without departing from the spirit and scope of the invention as defined in the appended claims.

### LIST OF REFERENCE SIGNS

1 Functional unit comprising a visual data output (for example, display)
3 Control unit
5 Sensor (for example, acceleration sensor)
7 Transfer measurement data (and possibly control of the sensor)
9 Controlling the wearable device by way of the control unit

What is claimed is:

1. A method for controlling a wearable device by recognition of tap gestures of a user at a carrying component, wherein the wearable device includes the carrying component configured to at least temporarily fix the wearable device to a body of the user, the wearable device further includes a functional unit connected to the carrying component and having a visual data output, at least one integrated circuit and at least one sensor configured to measure interactions caused by tap gestures, wherein the method comprises:
generating measurement data via the sensor; and,
controlling the wearable device by way of the integrated circuit by performing a functionality that corresponds to a tap gesture when the measurement data are identified as having arisen due to the tap gesture at the carrying component.

2. The method of claim 1, wherein the integrated circuit is included in a control unit.

3. The method of claim 2, wherein said controlling by way of the control unit comprises:
establishing a similarity of the measurement data with stored data patterns of tap gestures; and,
assigning the measurement data to a most similar tap gesture when a sufficient similarity is established.

4. The method of claim 2, wherein the sensor includes a second integrated circuit in the form of an internal regulating unit; and, said controlling the wearable device is effected in dependence upon at least one of the functionality, the tap gesture, and an operating state of the wearable device by an internal regulating unit or by the control unit.

5. The method of claim 4, wherein controlling is effected by way of the internal regulating unit when at least one of:
i. the wearable device is switched off or in standby mode;
ii. the functionality includes a wake-up function, switching the wearable device at least one of on and off; and,
iii. the tap gesture is a simple tap gesture defined by a number of tap actions.

6. The method of claim 5, wherein the number of tap actions is below a maximum number.

7. The method of claim 5, wherein the tap gesture is a simple tap gesture; and, wherein said controlling by way of the internal regulating unit comprises:
counting a number of tap actions; and,
assigning the tap actions to the simple tap gesture according to the number of tap actions.

8. The method of claim 7, wherein a simple tap gesture comprises at least one tap action and at most four tap actions.

9. The method of claim 2, wherein said controlling is effected by way of the control unit when at least one of
i. the wearable device is switched on; and,
ii. the tap gesture is a complex tap gesture.

10. The method of claim 9, wherein the complex tap gesture comprises a plurality of tap actions, the complex tap gesture is defined by at least one of a tap duration of the tap actions, a tap intensity of the tap actions, a tap period of the tap actions, a tap rhythm of the tap actions, and a number of tap actions greater than four.

11. The method of claim 1, wherein the sensor includes an acceleration sensor; and, wherein the measurement data includes acceleration data of the carrying component.

12. A wearable device configured to perform the method of claim 1, the wearable device comprising:
a carrying component configured to at least temporarily fix the wearable device to a body of a user;
a functional unit connected to said carrying component and including a visual data output;
at least one sensor configured to measure interactions caused by tap gestures;
at least one integrated circuit;
said sensor and said integrated circuit being configured to, on a basis of said measurement data, control the wearable device by way of a tap gesture at said carrying component.

13. A wearable device comprising:
a carrying component configured to at least temporarily fix the wearable device to a body of a user;
a functional unit connected to said carrying component and including a visual data output;
at least one sensor configured to measure interactions caused by tap gestures and generate measurement data;
at least one integrated circuit;
said sensor and said integrated circuit being configured to, on a basis of said measurement data, control the wearable device by way of a tap gesture at said carrying component.

14. The wearable device of claim 13, wherein said integrated circuit comprises a control unit; and, said sensor and said control unit are configured to perform a functionality corresponding to the tap gesture when said measurement data of said sensor are identified as having arisen due to the tap gesture at said carrying component.

15. The wearable device of claim 13, wherein:
said sensor includes a second integrated circuit in the form of an internal regulating unit;
said sensor and said internal regulating unit are configured to perform a functionality corresponding to the tap gesture when said measurement data of said sensor are identified as having arisen due to the tap gesture at said carrying component, and,
said internal regulating unit and said control unit are configured to control the wearable device via said internal regulating unit or via said control unit in dependence upon at least one of the functionality, the tap gesture, and an operating state of the wearable device.

16. The wearable device of claim 13, wherein said sensor comprises an acceleration sensor and the measurement data comprise acceleration data of said carrying component.

17. The wearable device of claim 13, wherein the wearable device includes a head-mounted display.
